(19) United States
(12) Patent Application Publication
(10) Pub. No.: US 2006/0068692 A1
(43) Pub. Date: Mar. 30, 2006

(54) Rib lifter

(75) Inventors: Richard S. Bruce, Knoxville, TN (US); Lawrence D. Boody, Oliver Springs, TN (US); Scott E. Andre, Cincinnati, OH (US)

Correspondence Address: PITTS AND BRITTIAN P C, P O BOX 51295, KNOXVILLE, TN, 37950-1295, US

(73) Assignee: Acraloc Corporation, Oak Ridge, TN (US)

(21) Appl. No.: 10/950,921

(22) Filed: Sep. 27, 2004

(51) Int. Cl. A22C 21/00

(52) U.S. Cl. 452/151

(57) ABSTRACT

An apparatus for separating ribs, namely the spare ribs, from a pork carcass belly, referred to as a rib lifter. The rib lifter automatically cuts and removes the spare ribs from a pork belly immediately following the process where the loin and baby back ribs have previously been removed. The part that needs to be removed from the pork belly consists of the brisket bone along with the additional ribs. The rib lifter detects the rib height and adjusts the rib blade to cut immediately below the ribs without nicking the rib material or going too deep in creating what is known in the industry as a “snowball,” a large white spot on the belly, thus making it unsalable.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention relates to an apparatus and a method used in the meat processing industry. More particularly, the present invention automatically separates the spare ribs and brisket bone from the pork belly.

2. Description of the Related Art

In the meat processing industry, specifically the pork processing industry, it is well known that it is a difficult and precise process for an operator to correctly remove the spare ribs from the pork belly. Using pork processing as an example, the first step is to halve the carcass by cutting it into equal sides through the center of the backbone. Each carcass side is processed to remove the hindquarter and the forequarter. The remaining middle portion of the carcass contains the loin and belly. A saw separates the baby back rib portion from backbone. The carcass middle is cut to separate the loin and the belly and the fatback is removed from the loin. Next, the spare ribs are separated from the belly and the remainder of the belly is processed as bacon and skirt-meat.

When removing the spare ribs from the belly, any cut in a direction other than directly below the rib bones and traveling along the seam has the potential to render either or both of the rib portion and the belly unsalable. Manual removal of the spare ribs uses a gripping conveyor table to move the belly while the operator cuts the spare ribs and brisket bone free using a knife. Because the carcass middle has been split into two sides, there is an operator assigned to each side of the conveyor table to separate the spare ribs from the belly for each side. The spare ribs are pulled off the belly and separated to a different conveyance apparatus while the belly moves on for further processing. The spare ribs also move on to a further processing station where they may be trimmed for specialty cuts such as St. Louis ribs.

Various attempts to automate the rib removal process have been made, examples of which are described in U.S. Pat. No. 3,789,456, issued on Feb. 5, 1974 to Richard E. Doerfer, et al., and in U.S. Pat. No. 3,546,737, issued on Dec. 15, 1970 to Richard R. Neebel, et al. Each of these patents is instructive as to the general structure and operation of a machine for separating the spare ribs from the belly, commonly referred to as a “rib lifter.” However, none of these machines can succinctly trim or remove the ribs with a special depth analysis system that can work up to line speeds of 1,200 pieces per hour.

### BRIEF SUMMARY OF THE INVENTION

An apparatus for separating ribs, namely the spare ribs, from a pork carcass belly, or rib lifter, is shown and described. The rib lifter automatically cuts and removes the spare ribs from a pork belly immediately following the process where the loin and baby back ribs have previously been removed. The part that needs to be removed from the pork belly consists of the brisket bone along with the additional ribs. The rib lifter detects the rib height and adjusts the rib blade to cut immediately below the ribs without nicking the rib material or going too deep in creating what is known in the industry as a “snowball,” a large white spot on the belly, thus making it unsalable.

The rib lifter includes a conveyance system, which incorporates both a moving lower bed, the conveyor, and a system of chain drives, which form the upper drive mechanism. Working together, the conveyor and the chain drives flatten the pork belly to provide a standardized cutting target and pull the belly through the rib lifter. The chain drives are biased towards the conveyor by a number of spring-tensioned arms, each carrying a guide wheel. The spare ribs are separated from the belly by a rib blade. Each end of the rib blade is mounted to a vertically-articulated positioner. Each positioner moves independently of the other allowing the height and the angle of the rib blade to be adjusted to follow the height and contour of the spare ribs.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates a front elevation view of one embodiment of a rib lifter;

FIG. 2 illustrates a side elevation view of the rib lifter of FIG. 1;

FIG. 3 illustrates a top plan view of one embodiment of the rib lifter of FIG. 1 showing the arrangement of the guide arms and the rib removal blade;

FIG. 4 illustrates one embodiment of the chain lifter shown in a lowered position;

FIG. 5 illustrates the chain lifter of FIG. 4 in a raised position;

FIG. 6 depicts a side elevation view of the processing of a belly by the rib lifter of FIG. 1; and

FIG. 7 illustrates a block diagram of the control circuit for the rib lifter of the present invention.

### DETAILED DESCRIPTION OF THE INVENTION

An apparatus for separating ribs, namely the spare ribs, from a pork carcass belly, or rib lifter, is shown generally as 100 in the figures. The rib lifter automatically cuts and removes the spare ribs from a pork belly immediately following the process where the loin and baby back ribs have previously been removed. The part that needs to be removed from the pork belly consists of the brisket bone along with the additional ribs. The rib lifter detects the rib height and adjusts the rib blade to cut immediately below the ribs without nicking the rib material or going too deep in creating what is known in the industry as a “snowball,” a large white spot on the belly, thus making it unsalable.

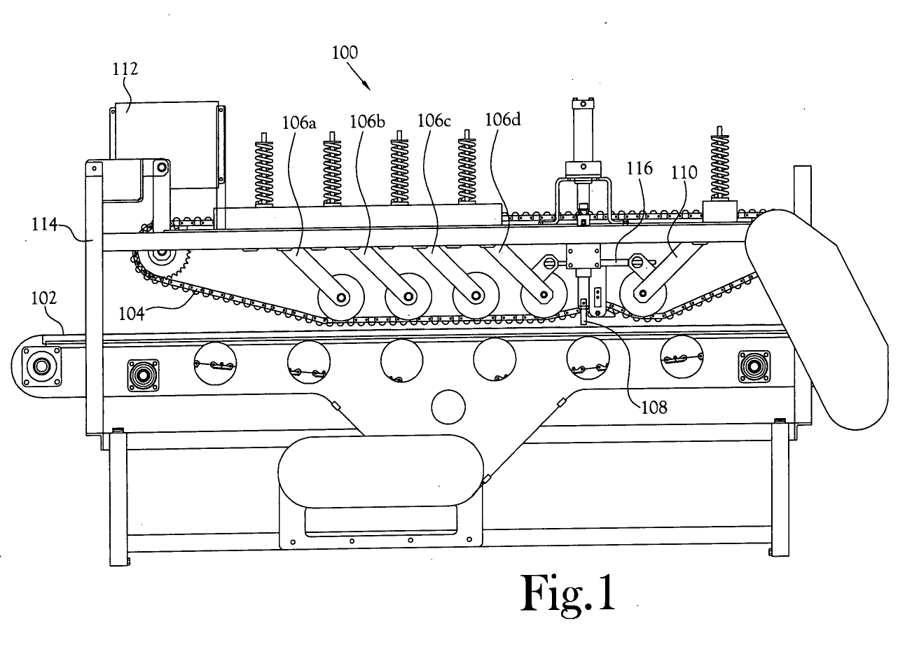

FIG. 1 illustrates a front elevation view of one embodiment of the rib lifter 100 of the present invention. The rib lifter 100 includes a conveyance system, which incorporates both a moving lower bed, the conveyor 102, and a system of chain drives 104, which form the upper drive mechanism. In one embodiment, the conveyor 102 has a high friction gripping surface such as that provided by a Series 800 Flush Grid Nub Top belt by Intralox L.L.C., and the chain drives 104 use half-moon gripping chains that provide good gripping characteristics without damaging the belly. Those skilled in the art will recognize other suitable belts for use in the rib lifter 100 of the present invention. Working together, the conveyor 102 and the chain drives 104 compress the pork belly to provide a standardized cutting target and pull the belly through the rib lifter 100. The chain drives 104 are biased towards the conveyor 102 by a number of spring-tensioned front-side guide arms 106a-d. Each guide arm 106a-d includes a guide wheel that, in cooperation with the other in-line guide wheels, forms a track for the chain. The spare ribs are separated from the belly by a rib blade 108. In the illustrated embodiment, four in-line guide arms associated with each chain drive 104 precede the rib blade 108. A back-side guide arm 110 in line with the leading guide arms 108a-d follows the rib blade 108 to maintain downward pressure on belly during near the rib blade 108. An electrical control box 112 mounted to the frame 114 contains the circuitry that controls the operation of the rib lifter 100. A chain lifter 116 between the last front-side guide arm 106d and the back-side guide arm 100 serves to guide the chains over the rib blade 108.

Finally, with respect to FIG. 1, one will note that only the front-most rib blade positioner and the front-most set of guide arms with the associated the front-most chain and springs are visible to simplify the drawing. The positions of both positioners and the offset guide wheel sets that are positioned behind the visible guide wheel set are illustrated in other figures. However, it should be noted that the guide wheel sets or the positioners could be arranged such that they are all laterally aligned without departing from the scope and spirit of the present invention.

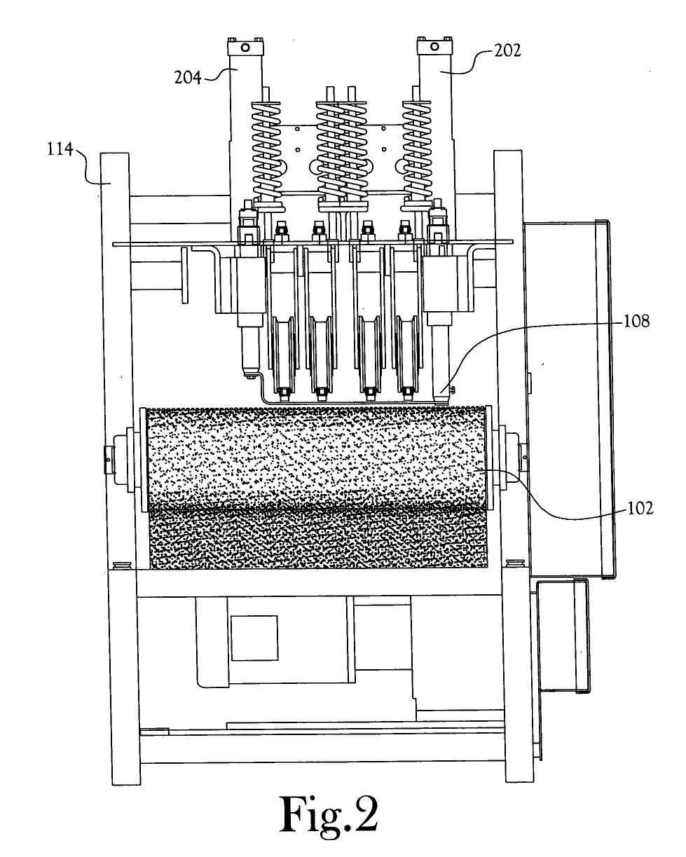

FIG. 2 illustrates a right side elevation view of the rib lifter 100. In the illustrated embodiment, there are four sets of in-line guide arms 200a-d that serve to apply the downward pressure to help convey the belly through the blade area and serve as a track for a set of four corresponding chains, which are not shown in the interest of clarity. The sets of guide arms 200a-d are positioned within the width of the rib blade 108, which is where the application of pressure is desirable to force the belly into a substantially flat profile. The rib blade 180 is a substantially U-shaped blade. The rib blade 180 moves via two vertically-articulated positioners 202, 204, each attached to one end of the rib blade 108. Each positioner 202, 204 moves independently of the other allowing the height and the angle of the rib blade 108 to be adjusted to follow the height and contour of the spare ribs. In the illustrated embodiment, the positioners 202, 204 are hydraulically actuated. Those skilled in the art will recognize other mechanisms for actuating the positioners without departing from the scope and spirit of the present invention include screw drives, pneumatic actuators, and other similar motor types.

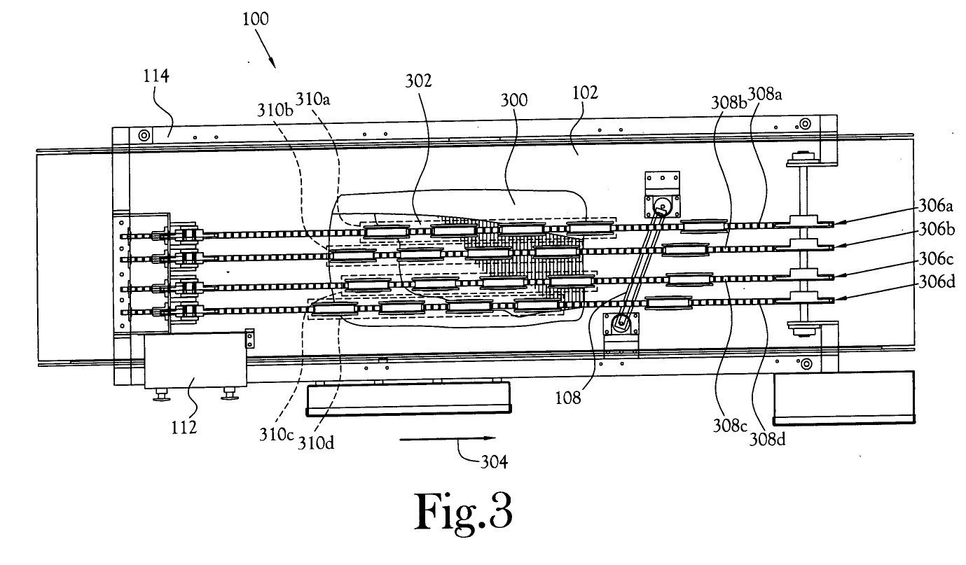

FIG. 3 is a top plan view of one embodiment of the rib lifter 100 illustrating the relative position of a belly 300 having an exposed spare rib portion 302 with respect to the rib blade 108. The rib lifter 100 is loaded with the assistance of a laser guide for optimum accuracy. The conveyor 102 moves the belly towards the rib blade 108 in the direction indicated by the arrow 304. From this view, one will note that the rib blade 108 is positioned at angle approximately 20° offset from the perpendicular of the conveyor 102. When the belly 300 is loaded in a straight, i.e., the edges are substantially parallel to the direction of travel 304, the angled rib blade 108 effectively separates the ribs 302 from the belly 300. Those skilled in the art will recognize that the angle of rib blade and/or the angle at which the belly is loaded onto the conveyer can vary so long as the resulting combination results in the rib blade being positioned to remove the spare ribs.

FIG. 3 also illustrates one arrangement for the guide arms of the chain drives 306a-d. The chain drives 306a-d cooperate with the conveyor 102 to move the belly 300 through the rib lifter 100. Generally, the chain drives 306a-d move at substantially the same speed as the conveyor 102. Each chain drive 306a-d includes a chain 308a-d and a set of in-line guide wheels 310a-d. Each wheel is carried by an independent biasing arm. The guide wheels sets 310a-d keep the chains 308a-d aligned and are downwardly-biased so that each chain 308a-d firmly engages and pulls the belly 300 through the rib lifter 100. In the illustrated embodiment, there are four chain drives shown; however, those skilled in the art will recognize that the number of chain drives can vary without departing from the scope and spirit of the present invention. The arrangement of the guide wheel sets 310a-d is designed to effectively move the belly 300 through the rib lifter 100 and facilitate the separation of the spare ribs from the belly 300. Those skilled in the art will recognize that the number, position, offset, and size of the guide wheels can vary and still provide satisfactory movement of the belly through the rib lifter.

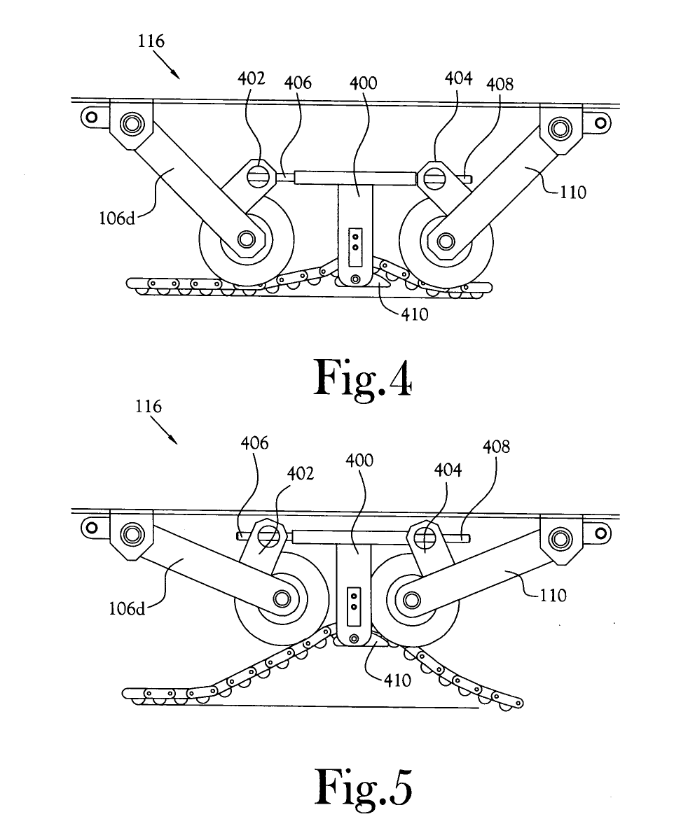

FIG. 4 illustrates one embodiment of the chain lifter 116 in detail at a lowered position. The chain lifter includes a t-bar 400 that is suspended between the last front-side guide arm 106d and the back-side guide arm 110. Each guide bar 106d, 110 is fitted with a bracket 406, 408 adapted to slidably receive an extension 406, 408 from the t-bar. The sliding motion of the extensions 406, 408 allows t-bar 400 to move with the guide arms 106d, 110 as they raise and lower in response to the height of the belly 300. The length of the extensions 406, 408 is selected to accommodate the distance between the front-side guide arm and the back-side guide arm. Also extending from the t-bar is a shelf 410. The chain rests on and travels over the rounded top surface the shelf 400. The rounded top surface of the shelf 400 allows the chain to move smoothly without snagging as the shelf 400 raises and lowers. FIG. 5 illustrates the chain lifter 116 in a raised position.

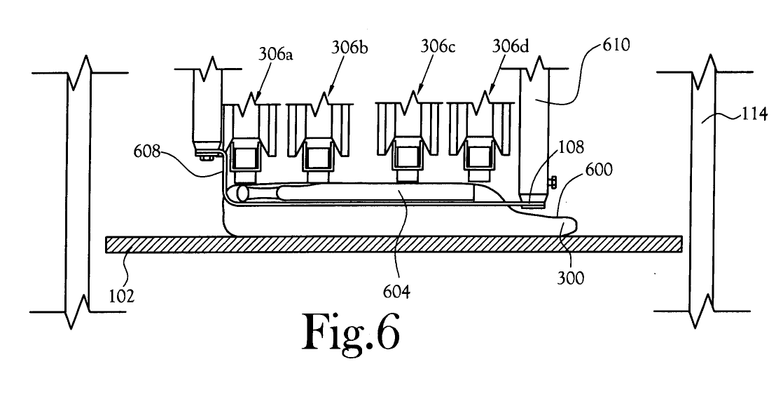

FIG. 6 is an end view of one embodiment of the rib lifter 100 of the present invention processing a belly 300. The rib blade 108 is adapted to lift the spare rib portion 302 from the belly 300. The height of the rib blade 108 is adjusted based upon the height of the belly 300 proximate to the spare rib portion 302. In one embodiment, the height of the belly is determined by at least one sensor associated with one or more of the guide arms. Where the belly is separated from the loin by a process that leaves a shelf of lean 600 on the belly 300, an alternate embodiment of the rib lifter 100 includes a sensor 602 that follows the contour of the shelf of lean 600 and generally abuts the exposed ribs 604. One embodiment of the shelf-of-lean sensor 602 is implemented using a floating guide rod. The guide rod engages the rib side 604 of spare rib portion 302. Through instrumentation, the guide rod provides position information useful for controlling the depth of the cut. In addition, the guide rod helps to maintain the straight-on alignment of the ribs relative to the rib blade 108.

In the illustrated embodiment, the rib blade 108 has a first end 606 and a second end 608. The first end 606 has a curved design which allows the rib blade 108 to separate the spare rib portion 302 from the belly 300 just past the cartilage 610 leaving the belly meat outside of the rib portion 302 intact. The second end 608 has a straight configuration that generally exits the belly and travels over the shelf of lean 600. In an alternate embodiment, the second end is curved similarly to the first end 606 to create a substantially U-shaped blade. Those skilled in the art will recognize that other configurations for the rib blade 108 can be used without departing from the scope and spirit of the present invention.

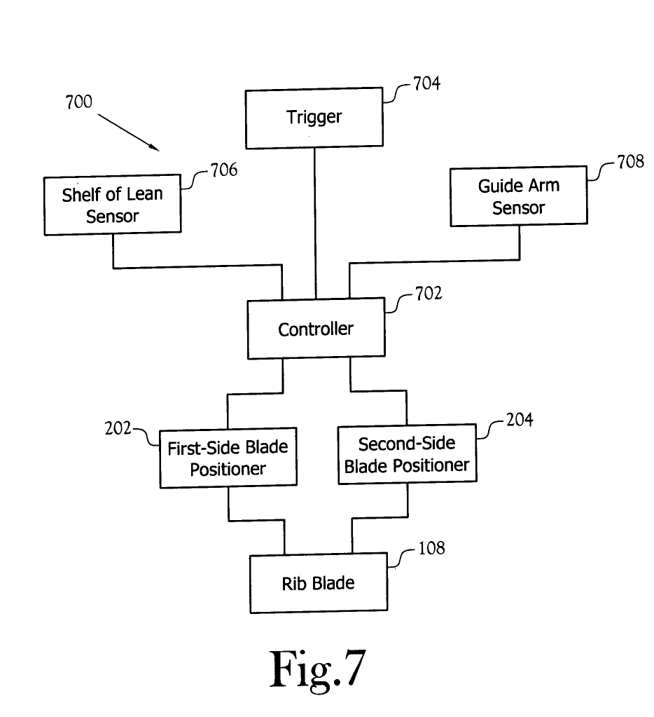

FIG. 7 is a block diagram of one embodiment of a control circuit 700 for the rib lifter 100 of the present invention. Central to the control circuit 700 is a controller 702. The controller is responsible for coordinating the cutting blades of the rib lifter 100 including the rib blade 108. The controller 702 reads inputs from various sensors to control the removal of the spare ribs 302 from the belly 300. One common input includes a trigger 704 that indicates the presence of a belly 300 on the conveyor 102.

In embodiments where a guide rod is used, the guide rod generally incorporated a shelf-of-lean sensor 706. The shelf-of-lean sensor 706 is carried by the guide rod and provides the controller 702 with preliminary information about the height of the rib line. Returning now to FIG. 6, the belly has been processed leaving a shelf of lean 600 next to the rib line 604. The guide rod engages the rib line 604, resting on the shelf of lean 600. Sensing the current position of the guide rod, the shelf-of-lean sensor 706 provides the controller 702 with data regarding the height of the rib line. Using this information, the controller 702 actuates the rib blade positioners 202, 204 to move the rib blade 108 into a starting position for the belly being processed.

The guide rod is generally considered to be floating and raises and lowers to follow the contour of the belly 300 traveling on the conveyor 102. The guide rod is generally held in a fixed position relative to the edge of the conveyor 102 but is free to move in a vertical direction to accommodate bellies of varying thickness. By being fixed in the horizontal direction, the guide rod serves as a useful mechanism for maintaining the alignment and position of a belly traveling on the conveyor 102. In another embodiment, however, the guide rod is positionable by the controller 702. Where a positionable guide rod 702 is used, the controller 702 retracts the guide rod when the rib puller 100 is idle. Once a signal is received from the trigger 704, the controller 702 moves the guide rod into position against the rib line 604.

Data from the shelf-of-lean sensor 706 is also used to verify that the rib portion 302 is properly positioned to engage the rib blade 108. Should the belly 300 be improperly positioned, the rib line 604 could be outside of the range of the rib blade 108. The cut is relatively close on the rib side 604 of the belly 300 compared to the margin on opposite side. The rib blade 108 is designed for slicing through tissue and not bone. Accordingly, if the rib line 604 falls outside the range of the rib blade 108, the controller can halt the rib lifter 100 and notify an operator of the error condition. Those skilled in the art will recognize that the rib lifter can be equipped to automatically realign the belly, if desired.

The rib lifter 100 may also include one or more sensors associated with the guide arms. For simplicity, the rib lifter 100 of the present invention is described referencing a single guide arm sensor 708; however, those skilled in the art will appreciate that additional guide arm sensors would operate in a similar fashion. The output of the guide arm sensor 708 senses changes in the vertical position of the guide arm. The position data from the guide arm sensor is provided to the controller 702, which uses the position data to adjust the height of the rib blade 108 through the positioners 202, 204. While the mechanical illustration of the guide arm sensor has not been show, those skilled in the art will recognize the various sensor types and configurations that can be used to implement a guide arm sensor. One example is a linear variable differential transducer (LVDT) attached to the guide arm. Further, one skilled in the art will recognize that other height sensor arrangements could be substituted for the guide arm sensor in alternate embodiments. Such modifications, including the use of laser distance sensors or other optical sensors, are deemed to be within the purview of those skilled in the art.

Calculation of the rib blade position is most simply accomplished by taking the height values obtained from the shelf-of-lean sensor 706 and/or the guide arm sensor 708 and adding an offset to determine the proper position of the rib blade 108 to remove the spare rib portion 206 without snowballing the belly 300. When at least two sensors are employed, which could be the shelf-of-lean sensor 706 and a guide arm sensor 708 located proximate to the opposite side of the belly from the rib line 204, sufficient data is available to the controller 702 to independently adjust the ends of the rib blade 108. The addition of further sensors offers additional data for the controller 702 to utilize when calculating the position of the rib blade 108.

Those skilled in the art will recognize the various types of processing devices that can be used to implement the controller of the rib lifter. Such processing devices in programmable logic controllers, programmable interrupt controllers, processors and microprocessors, and discrete logic components.

A rib lifter has been shown and described. A series of chain drives cooperate with a conveyor to move a belly through a rib blade that cuts the spare rib portion free from the belly. A controller responsive to the shelf-of-lean sensor preliminarily adjusts the height of the rib blade and the scoop blade to remove the ribs without creating a snowball in the belly. Additional sensors in the rib lifter provide the controller with further height data to refine the position of the rib blade and the scoop blade.

While at least one embodiment has been shown and described, it will be understood that it is not intended to limit the disclosure, but rather it is intended to cover all modifications and alternate methods falling within the spirit and the scope of the invention as defined in the appended claims.

Having thus described the aforementioned invention, we claim:

1. A meat-processing apparatus for removing ribs from a belly, said meat-processing apparatus comprising:
a conveyor for carrying a belly, the belly having a bottom surface, a top surface, and a spare rib portion defining a rib line, said conveyor having a surface adapted to grip the bottom surface of the belly;
a chain drive biased towards said conveyor and adapted to engage the belly, said chain drive cooperating with said conveyor to move the belly, said chain drive including a plurality of guide arms biased towards said conveyor and a plurality of guide wheels, each guide wheel carried by one of said plurality of guide arms, said plurality of guide wheels providing a track for a chain, said chain adapted to grip the top surface of the belly;
a rib blade having a first end, a second end, and a cutting surface, said cutting surface positioned to engage and cut through the belly around the spare rib portion;
a first positioner connected to said rib blade first end, said first positioner moving said rib blade first end in a vertical direction;
a second positioner connected to said rib blade second end, said second positioner moving said rib blade second end in a vertical direction independent of said first positioner;
a shelf-of-lean sensor for sensing the height of the rib line;
a guide arm sensor for sensing the height of the belly based upon a position of said guide arm, said guide arm sensor carried by one of said plurality of guide arms; and
a controller in communication with said shelf-of-lean sensor, said guide arm sensor, said first positioner, and said second positioner, said controller performing a method comprising the steps of:
reading a first value from said shelf-of-lean sensor;
adding an offset to said first value to produce an initial rib blade position;
reading a second value from said guide arm sensor;
adding an offset to said second value to produce a secondary rib blade position
actuating said first positioner to move said rib blade first end to a position based on said initial rib blade position; and
actuating said second positioner to move said rib blade second end to said secondary rib blade position.

2. The meat-processing apparatus of claim 1 further comprising a guide rod aligned parallel to said conveyor, said guide rod adapted to rest upon the belly against the rib line, said guide rod height corresponding to a height of the rib line; said shelf-of-lean sensor sensing the rib line height based upon a position of said guide rod.

3. The meat-processing apparatus of claim 1 further comprising a trigger switch in communication with said controller, said trigger switch providing an indication to said controller that a belly is present on said conveyor.

4. A meat-processing apparatus for removing ribs from a belly, said meat-processing apparatus comprising:
a conveyor for carrying a belly have a spare rib portion;
a chain drive biased towards said conveyor and adapted to engage the belly, said chain drive cooperating with said conveyor to move the belly, said chain drive having at least one guide arm supporting a guide wheel, said guide wheel providing a track for a chain, said chain adapted to grip the belly;
a rib blade having a first end, a second end, and a cutting surface, said cutting surface positioned to engage and cut through the belly below the spare rib portion;
a first positioner connected to said rib blade first end, said first positioner moving said rib blade first end in a vertical direction;
a second positioner connected to said rib blade second end, said second positioner moving said rib blade second end in a vertical direction independent of said first positioner;
a shelf-of-lean sensor for sensing the height of the rib;
a guide arm sensor for sensing the height of the belly based upon a position of said guide arm; and
a controller in communication with said shelf-of-lean sensor, said guide arm sensor, said first positioner, and said second positioner, said controller adjusting said first positioner and said second positioner based upon inputs from said shelf-of-lean sensor and said guide arm sensor.

5. The meat-processing apparatus of claim 4 wherein said shelf-of-lean sensor is carried by a guide rod aligned parallel to said conveyor, said guide rod adapted to rest upon the belly against the ribs, said guide rod height corresponding to the rib line height.

6. The meat-processing apparatus of claim 4 wherein said guide arm sensor is carried by said at least one guide arm.

7. The meat-processing apparatus of claim 4 further comprising a trigger switch for providing an indication to said controller that a belly is present on said conveyor.

8. A meat-processing apparatus for removing ribs from a belly, said meat-processing apparatus comprising:
a conveyor for carrying a belly have a spare rib portion;
a chain drive biased towards said conveyor and adapted to engage the belly, said chain drive cooperating with said conveyor to move the belly, said chain drive having at least one guide arm supporting a guide wheel, said guide wheel providing a track for a chain, said chain adapted to grip the belly;
a rib blade having a first end, a second end, and a cutting surface, said cutting surface positioned to engage and cut through the belly below the spare rib portion;
a positioner connected to each of said rib blade first end and said rib blade second end, said positioner moving said rib blade in a vertical direction;
a shelf-of-lean sensor for sensing the height of the rib line;
a rib height sensor for sensing the height of the belly based upon a position of said guide arm; and
a controller in communication with said shelf-of-lean sensor, said rib height sensor, said first positioner, and said second positioner, said controller adjusting said first positioner and said second positioner based upon inputs from said shelf-of-lean sensor and said rib height sensor.

9. The meat-processing apparatus of claim 8 wherein said shelf-of-lean sensor is carried by a guide rod aligned parallel to said conveyor, said guide rod adapted to rest upon the belly against the ribs, said guide rod height corresponding to the rib line height.

10. The meat-processing apparatus of claim 8 wherein said rib height sensor is carried by said guide arm.

11. The meat-processing apparatus of claim 8 further comprising a trigger switch for providing an indication to said controller that a belly is present on said conveyor.

12. A meat-processing apparatus for removing ribs from a belly, said meat-processing apparatus comprising:
a means for transporting a belly have a spare rib portion;
a means for sensing a height of the belly;
a means for determining a cut line to remove the spare ribs from the belly based upon a height sensed by said a means for removing the spare ribs from the belly;
a means for separating the spare ribs from the belly along the cut line; and
a means for adjusting a height of said means for separating the spare ribs from the belly based upon a control signal from said means for determining a cut line.

13. A meat-processing apparatus for removing ribs from a belly, said meat-processing apparatus comprising:
a conveyance system for transporting a belly, the belly having a spare rib portion defining a rib line, said conveyance system including a conveyor and a cooperating set of chain drives, said set of chain drives including a plurality of guide arms engaging a top surface of the belly;
a sensor for sensing a height of said belly;
a positionable rib blade adapted cut through the belly around the spare rib portion, said rib blade positioned based upon the height sensed by said sensor.

14. The meat-processing apparatus of claim 13 wherein each of said set of chain drives are biased towards said conveyor and adapted to engage the belly, each of said set of chain drives cooperating with said conveyor to move the belly, each said guide arm associated with each said set of chain drives including a guide wheel providing a track for a chain, said chain adapted to grip the top surface of the belly.

15. The meat-processing apparatus of claim 13 wherein said positionable rib blade includes a blade having a cutting surface and a pair of positioners connected to and adapted to move said blade in a vertical direction.

16. The meat-processing apparatus of claim 15 wherein each of said pair of positioners independently moves one end of said blade.

17. The meat-processing apparatus of claim 13 wherein said sensor is associated with one of said guide arms, said sensor determining a height of the belly based upon a position of said guide arm.

18. The meat-processing apparatus of claim 13 further comprising a guide rod aligned substantially parallel to the direction of travel of said conveyance system, said sensor being associated with said guide rod and determining a height of said belly based upon a position of said guide rod.

19. The meat-processing apparatus of claim 13 further comprising a controller using the height obtained from said sensor to calculate a vertical position for said positionable rib blade selected to remove the spare rib portion from the belly.

20. The meat-processing apparatus of claim 13 further comprising a trigger switch providing an indication to said controller that a belly is present on said conveyor.
